(19) United States
(12) Patent Application Publication
(10) Pub. No.: US 2008/0201199 A1
(43) Pub. Date: Aug. 21, 2008

(54) SYSTEM AND METHOD FOR BEHAVIORIAL PSYCHOLOGY AND PERSONALITY PROFILING TO ADAPT CUSTOMER SERVICE COMMUNICATIONS

(75) Inventors: Michael Armstrong, Glen Allen, VA (US); Shawn Budde, Richmond, VA (US); Mina Buenviaje-Tice, Glen Allen, VA (US); Eric Lowell, Glen Allen, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Capital One Financial Corporation, Mclean, VA (US)

(21) Appl. No.: 11/676,004

(22) Filed: Feb. 16, 2007

(51) Int. Cl. G06Q 30/00

(52) U.S. Cl. 705/10

(57) ABSTRACT

Systems and methods for behavioral psychology system are provided. The system gathers information about one or more users to form a profile, and adapts the customer's interaction based on the profile.

### FIELD OF THE INVENTION

The present invention relates to a system and method for behaviorally profiling a customer in order to adapt the customer's experience with an entity.

### BACKGROUND OF THE INVENTION

Customers cut across a wide range of psychological, behavioral, and personality types. For example, some customers may be heavily transaction-oriented, and prefer to receive information without a great deal of personal interaction. Other customers greatly prefer personal interaction, and may not enjoy a mechanical and task-oriented experience. Some customers may understand and process information more easily in text form, and others might understand information more easily in picture form. Designing a single user interface which appeals to all types of customers may be difficult or impossible, or may be too burdensome to use efficiently. The lack of an interface specifically crafted to a customer's particular behavioral, psychological, and personality preferences may create a frustrating customer experience. The customer may then look to other commercial entities in an attempt to meet this psychological need. Further, it would be useful for commercial entities to know if a majority of its customers are of a particular behavioral or psychological group, as it could more effectively allocate resources to meet the needs of the majority group or groups.

### SUMMARY OF THE INVENTION

Accordingly, various embodiments of the present invention may be directed to a system and method for using behavioral psychology and personality profiling to adapt customer service communications by collecting information about one or more users, creating one or more behavioral profiles for the users based on the information collected, and adapting user interaction based on at least one of the one or more behavioral profiles for the users. Various embodiments may also include collecting the information from an on-line survey, on-line habits, a game, card transactions, a telephone survey, a letter, or an in-person interview. The one or more behavioral profiles may be updated based on additional information gathered from or about the customer. The one or more behavioral profiles of the one or more customers may be stored for recall in a database. The user interaction may be interaction with a web page, interaction with one or more computer images, a telephone call, an in-store visit by the customer, or interaction with an automated teller machine. The adaptation may include changing the amount of text presented to the users based on at least one of the one or more behavioral profiles, or presenting predominantly figures or predominantly text to the users based on at least one of the one or more behavioral profiles, or providing more or less interaction with a customer representative to the users based at least one of the one or more behavioral profiles.

Various embodiments of the present invention may also be directed to a method for using behavioral psychology and personality profiling to adapt customer service communications by collecting information about one or more users, creating one or more behavioral profiles for each of the users, and transmitting at least one of the one or more behavioral profiles to a system for use in adapting user interaction based on the behavioral profiles for the users.

Various embodiments of the present invention may also be directed to a system for using behavioral psychology and personality profiling to adapt customer service communications by providing a collection system to collect information about one or more users, providing a behavioral system for creating one or more behavioral profiles for each of the users based on information collected from the collection system, and providing an interaction system that can adjust user interaction based on at least one of the one or more behavioral profiles created by the behavioral system for the users.

Other embodiments are also within the scope of the invention.

### BRIEF DESCRIPTION OF THE DRAWINGS

The present invention, together with further objects and advantages, may best be understood by reference to the following description taken in conjunction with the accompanying drawings, in the several Figures of which like reference numerals identify like elements, and in which:

FIG. 1 is a system level block diagram illustrating components of a system for a personality profiling system according to at least one embodiment of the invention;

FIG. 2 is a system level block diagram illustrating the behavioral database component of a personality profiling system according to at least one embodiment of the invention;

FIG. 3 is a system level block diagram illustrating the financial system component of a personality profiling system according to at least one embodiment of the invention;

FIG. 4 is a flow chart illustrating a customer's on-line interaction with a financial system according to at least one embodiment of the invention;

FIG. 5 is a flow chart illustrating a customer's telephonic interaction with a financial system according to at least one embodiment of the invention;

FIG. 6 is a flow chart illustrating a customer's in-person interaction with a financial system according to at least one embodiment of the invention;

FIG. 7 is a diagram illustrating communication from the financial institution to the customer with a behavioral profile according to at least one embodiment of the invention;

FIG. 8 is a diagram illustrating communication from the financial institution to the customer with a different behavioral profile than in FIG. 7 according to at least one embodiment of the invention; and

FIG. 9 is a diagram further illustrating features of FIG. 8 according to at least one embodiment of the invention.

### DETAILED DESCRIPTION

The following description is intended to convey a thorough understanding of the embodiments described by providing a number of specific embodiments and details involving systems and methods for a behavioral psychology and personality profiling system. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the invention; the invention is not intended to be limited to financial institutions only. The invention may be used wherever customer interaction may be altered according to a customer's behavioral or personality type.

According to various embodiments of the present invention, a personality profiling system may utilize inputs in the form of pre-existing customer data or customer interviews or customer questionnaires, to create one or more behavioral profiles regarding the customer. The personality profiling system then may utilize the one or more behavioral profiles in order to create customer interaction which is advantageous to the customer's one or more behavioral profiles. The behavioral profiles may be changed or refined based on further interaction and feedback from the customer.

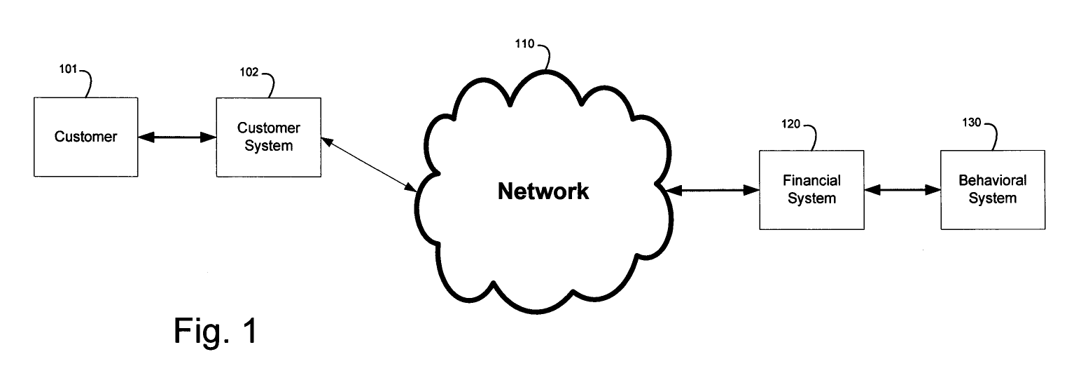

Turning to FIG. 1, a system level block diagram of one embodiment of the personality profiling system is shown. One embodiment of the invention may have a financial system 120 in communication with a behavioral database. The financial system 120 may also be in communication with a network 110. The user or customer may interact with a system to access the financial system 120 across the network 110, or other mechanisms may be used to input customer behavioral data into the behavioral system 130, as described more fully below.

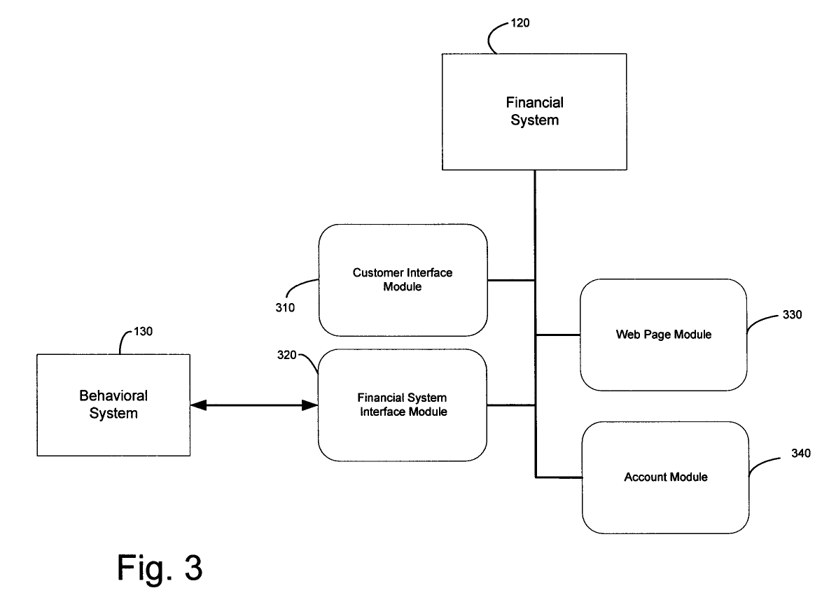

Turning now to FIG. 3, an exemplary financial system 120 is shown according to one embodiment of the present invention. The financial system 120 may be generally operable to store and present financial data. Financial data may include account information, computerized images of checks, customer interaction information, or any other kind of data kept by a financial institution about or for customers. The financial system 120 may contain one or more of the following modules: a customer interface module 310, a web page module 330, a financial system interface module 320, and an account module 340. Depending on the scope of the financial institution, the financial system 120 may have other modules to store and process customer account information. The customer interface module 310, the web page module 330, the financial system interface module 320, and the account module 340 may communicate with some or all of the modules. The modules of the financial system 120 may be part of a single system, or the modules may be physically or logically separated. The financial system 120 may be operably connected to the network 110 so that the financial system 120 modules are able to receive signals from the network 110 and generate signals to the network 110.

The customer interface module 310 may include a mechanism for customer authentication. The web page module 330 may include a web server and one or more web pages, which may be combined with information about the customer in order to present information to the customer across the network 110. The account module 340 may contain account information about one or more customers, such as current balance or transaction history. The financial system interface module 320 may provide an interface between the financial system 120 and the behavioral system 130, so that the two systems may be in communication and may share information.

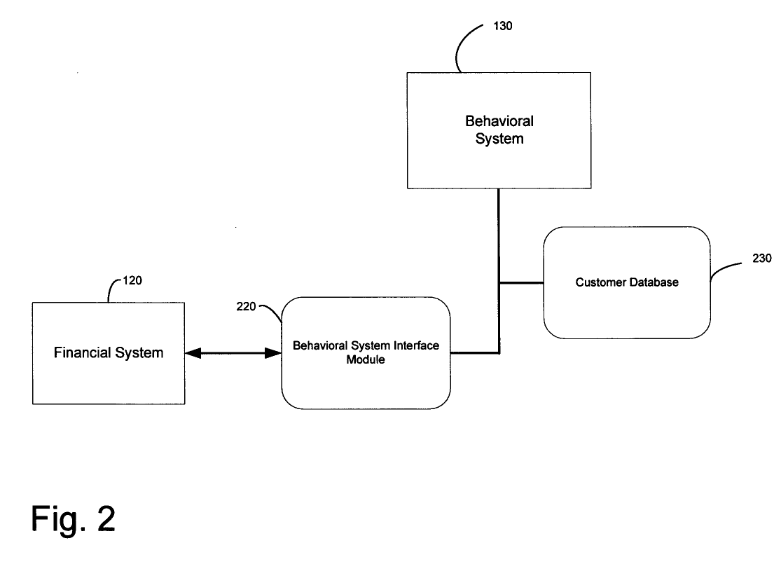

Turning now to FIG. 2, the behavioral system 130 may be generally operable to store behavioral and personality information regarding one or more customers. The behavioral system 130 may contain one or more of the following modules: an interface module 220 and a customer database 230. Depending on the scope of the financial institution, the behavioral system 130 may have other modules to store and process customer account information. The interface module 220 and the customer database 230 may communicate with some or all of the modules. The modules of the behavioral system 130 may be part of a single system, or the modules may be physically or logically separated. The behavioral system 130 may be operably connected to the network 110 so that the behavioral system 130 modules may be able to receive signals from the network 110 and generate signals to the network 110. While the behavioral system 130 and the financial system 120 are shown in direct communication, this may not be implemented. The behavioral system 130 may be operably connected to the network 110 as a stand-alone system, and communicate to the financial system 120 through the network 110, or may be operably connected to the network 110 such that the customer may interact with the behavioral system 130 (e.g., directly).

The customer database 230 may be operable to store one or more records regarding the personality data about one or more customers. The customer database 230 may store a customer identifier, for example a customer serial number or customer identification number. One or more behavioral profiles may be associated with the customer identifier in the customer database 230. While the customer database 230 has been described as a database, it should be appreciated by one of ordinary skill in the art that the customer database 230 may store and recall customer records by a number of different methods. For example, the customer database 230 could be a single electronic file, or multiple electronic files, or a spreadsheet. The customer database 230 may also be a relational database or any other form of data storage.

The behavioral system interface module 220 may provide an interface between the financial system 120 and the behavioral system 130, so that the two systems may be in communication and may share information. The behavioral system 130 and the financial system 120 may be in direct communication, or may communicate with each other across a network 110. If the behavioral system 130 is in communication with the network 110, the behavioral system interface module 220 may be operable to transmit signals to the network 110 and to receive signals from the network 110.

The customer may operate a customer system 102 to interface with the financial system 120. The system may be in communication with the financial system 120 via a network 110. In one embodiment, the system may contain an interface to view information received from the financial system 120 over the network 110. A system may include, but is not limited to: e.g., any computer device, or communications device including, e.g., a personal computer (PC), a workstation, a mobile device, a phone, a handheld PC, a personal digital assistant (PDA), a thin system, a fat system, an network appliance, an Internet browser, a paging, an alert device, a television, an interactive television, a receiver, a tuner, a high definition (HD) television, an HD receiver, a video-on-demand (VOD) system, a server, or other device.

Though not depicted in FIGS. 1-3, those of ordinary skill in the art will appreciate that a plurality of potential customer systems 102 may be used by the customer to interact with the financial system 120 or behavioral system 130. For example, if the network 110 comprises the Internet, the customer system 102 may interact with the financial system 120 to view information and input preferences via a web browser client installed on the customer's system 102, such as INTERNET EXPLORER, NAVIGATOR, or FIREFOX web browser programs, offered by Microsoft Corporation of Redmond, Wash., Time Warner of New York, N.Y., and the Mozilla Foundation of Mountain View, Calif., respectively. Those of ordinary skill in the art will appreciate that computer systems may include traditional desktop and laptop computer systems as well as Personal Digital Assistants (PDAs), mobile phones, BLACKBERRY devices, and other portable communication devices. These devices all typically include some form of browser client that enables a person to view content delivered across the Internet. Web browser programs may include HTTP browsers, as well as Wireless Application Protocol (WAP) browsers, or any other suitable browser based on currently known or previously un-standardized Internet protocols.

A network may include, but is not limited to: e.g., a wide area network (WAN), a local area network (LAN), a global network such as the Internet, a telephone network such as a public switch telephone network, a wireless communication network, a cellular network, an intranet, or the like, or any combination thereof. In exemplary embodiments of the invention, the network may include one, or any number of the exemplary types of networks mentioned above operating as a stand-alone network or in cooperation with each other. Use of the term network herein is not intended to limit the network to a single network.

Many different behavioral profiles may be possible, and many different combinations of specific behaviors may yield many different overall behavioral profiles. Several types of customer behavioral groups are shown below. They are intended to be an exemplary list and an explanation of possible behavioral groups and are not intended to be limiting on the invention. For example, a customer may be high-technology or low-technology. High-technology customer groups may prefer interacting with the financial institution via a computer interface, and may prefer to receive information from the financial institution via electronic mail or text message. Low-technology customer groups may prefer interacting with the financial institution via regular mail or in-person, and may not enjoy receiving information electronically. A transactional customer group may prefer to receive bare information from a customer representative or from a web page, and may not enjoy talking with a customer representative about irrelevant subjects. A relationship oriented customer group may enjoy making a bond with a customer representative through conversation not directly relevant to the sale of financial services, and may find the preferred interaction method of the transactional customer cold and impersonal. A text oriented customer group may prefer to see information in the form of text (i.e., a column of numbers or a list of percentages), while a picture oriented customer group may prefer to see information in the form of pictures (i.e., graphs and charts). A heavy explanation customer group may demand or require a thorough explanation of products and terms, and may have very detailed questions to ask a specialized customer representative. On the other hand, a light explanation customer group may want only a minimum amount of facts to make a decision, and may not enjoy sifting through the information required by the heavy explanation customer group.

A customer may belong to one or more of the behavioral groups, and a behavioral profile may involve one or more of the behavioral groups. For example, a customer may be placed in a high-technology customer group and also in a picture oriented customer group and a light explanation customer group. The customer would be identified as preferring an electronic interaction with the financial institution, with only enough charts and graphs to help the customer make their decision. A small change of one or more of the behavioral groups may make a large change to the overall behavioral profile. For example, a high-technology, picture oriented, light explanation customer would not enjoy the communications directed to a high-technology, picture oriented, heavy explanation customer. The first customer may prefer to receive only enough information to make a choice, and may not enjoy finding the few pieces of information necessary for a decision inside of a lengthy and multi-page prospectus document. The second customer may prefer to receive more information than is actually necessary in order to feel satisfied making a choice, and may become frustrated upon receiving a short single page overview document.

The customer may be assigned into one or more specific behavioral profiles before the customer's first interaction with the financial system 120, or after the customer's first interaction with the financial system 120 (e.g., without the customer's knowledge). For example, the customer may subscribe to a financial service via a web page, and the behavioral system 130 may recognize the fact that the customer chose to sign up for the service via a web page as a signal that the customer fits into a specific group, for example a high-technology group. Or, the customer may subscribe to a financial service with an in-store consultation, and the behavioral system 130 may recognize the fact that the customer chose to sign up for the service via an in-store consultation as a signal that the customer fits into another specific group, for example a relationship-oriented group.

Additional information may be considered by the behavioral system 130 in arriving at a behavioral profile for a customer. For example, the customer's spending habits may be scrutinized. Based on the behavioral profiles of other customers or based on other rules contained in the behavioral system 130 concerning individual stores or groups of stores, shopping at a particular store or group of stores may be indicative of a behavioral profile. The customer's behavioral profile may thus be created or refined based on transaction history information.

The customer may also be assigned into one or more specific behavioral profiles after consultation with the customer. For example, the customer may be invited to answer one or more questions, and the answers to the questions may be used by the behavioral system 130 to place the customer into one or more behavioral profiles or to refine an existing behavioral profile. Or, the customer may be assigned into one or more specific behavioral profiles after a consultation with a customer representative either in-person, or via telephone or videoconference or an interactive computer chat function. The customer representative may ask questions of the customer, and enter the replies in the behavioral system 130. The behavioral system 130 may then create, modify, or refine a behavioral profile for the customer based on the responses. Or, the customer may be invited to play a game over the network 110. The customer's responses to the game stimuli may be transmitted to the behavioral system 130, which may then create or refine a behavioral profile for the customer based on the responses.

The behavioral profile may be created or further refined from one or a number of input data points. For example, the behavioral profile may be created from the customer's transaction history or by a series of questions that a customer representative may ask a customer and input into the behavioral system 130. Several methods of gathering input data may also be used in order to check one method against the other, either to validate or refine the methods used for future customers or for a check to ensure the customer is in a proper behavioral type. For example, if the customer's transaction history suggests that they should be in a high-technology behavioral type (i.e., they bought a computer at a technology store, or subscribed to broadband internet services), but the customer indicates in an in-person interview with a customer representative that they do not enjoy using computers, then the customer may be placed into a low-technology behavioral group rather than the high-technology behavior group that the transaction history alone might suggest.

The customer's behavioral profile may be constantly refined as the behavioral system 130 learns more about the customer. For example, the customer's future purchases may be considered, and the customer's behavioral profile may be updated or refined based, in part, on this new information. Or the customer may be invited to play a game over the network 110, and the responses may be used to update or refine the behavioral profile. Or the customer may be asked questions when interacting with the financial system 120, and those responses may be used to update or refine the behavioral profile. Or the customer's interaction with the financial system 120 over the network 110 may be monitored, and the customer's behavioral profile may be updated or refined based on the information from the financial system 120. For example, the customer may have been placed in a text-based behavioral profile, but may consistently request the financial system 120 to display data in a graph or other pictorial form. This data may be transmitted to the behavioral system 130, which may use the data, and eventually move the customer from a text-based behavioral profile to a picture-based behavioral profile. Or, the customer may request to be transferred to another behavioral profile, and the behavioral system 130 may use this data to override the existing behavioral profile for the customer. For example, the customer may have shopped at a technology store, and the behavioral system 130 may have identified that fact from transaction histories and placed or moved the customer into a high-technology behavioral group. The customer may realize this and call the financial institution or transmit a request to the financial system 120 across the network 110 that the customer wishes to be in a low technology group. The behavioral system 130 may use this data to override the existing data and place the customer in a low technology group anyway.

In an embodiment, the customer may use a telephone to communicate with a customer representative, and the customer representative may create or change the customer's information or preferences in the behavioral system 130. The customer may also send information on preferences through the mail or facsimile where a customer service representative receives the letter or facsimile and creates or changes the customer's information or preferences in the behavioral system 130.

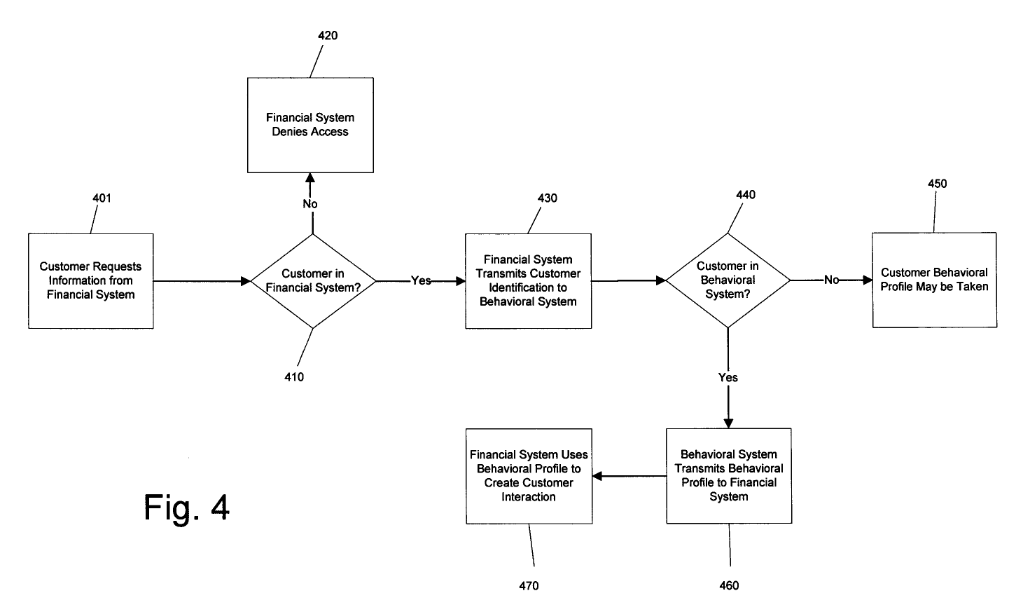

Turning now to FIG. 4, a customer may use a network 110 to interact with the financial system 120 of the financial institution. For example, the customer may be able to check his or her account balance by using the client and transmitting and receiving signals from the financial system 120 via the network 110. Or, the customer may interact with the financial system 120 via an automated teller machine. The financial system 120 may have a web page module which may be used to produce web pages and transmit them across the network 110 to the client. The customer may operate the customer system 102 to transmit a request to the financial system 120, shown in block 401. The request may include authentication information (i.e., a username and password combination, or a password, or any other type of authentication mechanism as is common in the art). As shown in block 410, if the financial system 120 does not authenticate the customer, the process may terminate and the customer may try to re-send new authentication information, shown in block 420. The financial system 120 may transmit the customer's unique identification to the behavioral system 130 via the financial system interface module 320, as shown in block 430. The behavioral system 130 may receive the customer's unique information via the behavioral system interface module 220, and may transmit the customer's unique identification to the customer database 230. Depicted in block 440, if the customer is associated with one or more behavioral profiles, the customer database 230 may transmit the one or more behavioral profiles to the behavioral system 130, which may transmit them to the financial system 120, shown in block 460. If the customer is not associated with a behavioral profile, the customer database 230 may transmit an error code to the behavioral system 130, which may transmit the error code to the financial system 120, shown in block 450.

If the financial system 120 receives an error code from the behavioral system 130, the financial system 120 may proceed to request data from the customer. The data may be gained in the form of a series of questions that the financial system 120 presents to the customer. The answers to the questions may be transmitted from the financial system 120 to the behavioral system 130 via the financial system interface module 320. The behavioral system 130 may receive the answer data via the behavioral system interface module 220. The behavioral system 130 may use the answer data to create one or more behavioral profiles for the customer. The one or more behavioral profiles may be transmitted to the financial system 120 for use in creating the user interface for the customer. In an alternate embodiment of the present invention, the financial system 120 may present a game to the customer, during which the customer responds to one or more stimuli in the game and the financial system 120 receives the customer responses. The financial system 120 may then transmit the customer responses to the behavioral system 130, where one or more behavioral profiles may be created and transmitted to the financial system 120 for use in creating the user interface for the customer.

The financial system 120 may use the one or more behavioral profiles in order to create a user interface for the customer, shown in block 470. The user interface may be tailored so that information is presented in a way that appeals to the one or more behavioral profile embodied in the customer, or in a way such that the information is most readily absorbed by the customer given the customer's one or more behavioral profiles.

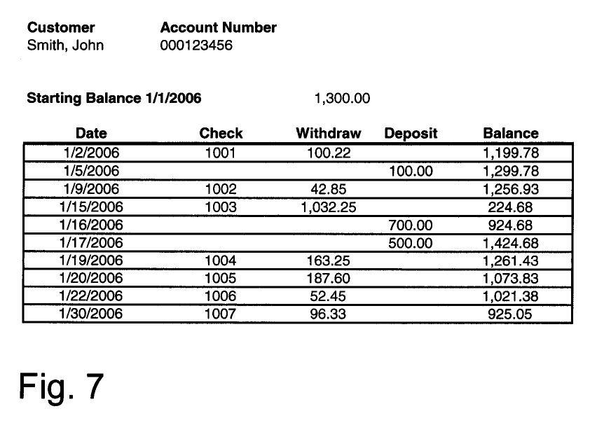

Turning now to FIG. 7, an exemplary embodiment of a statement display for a customer who may be in a text-based behavioral group is shown. FIG. 7 shows a table of values corresponding to deposits and withdraws that the customer made during the reported month. It should be apparent to one of skill in the art that the display depicted in FIG. 7 is exemplary of the present invention, and that many other activities could be reported through the financial system 120.

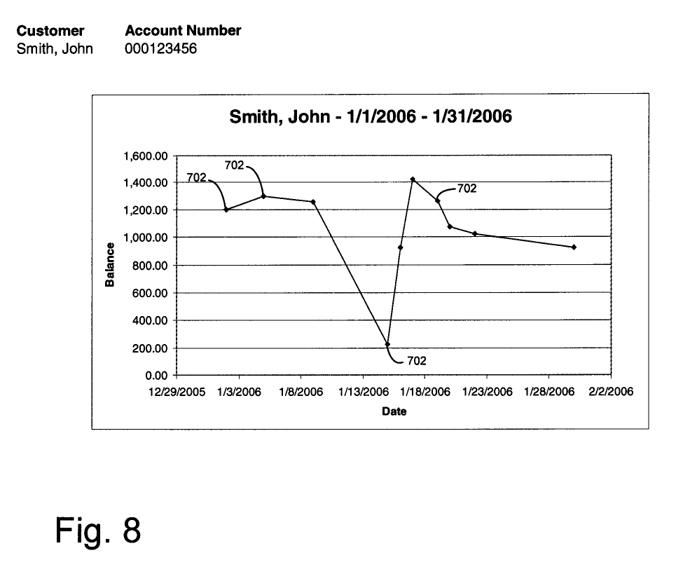

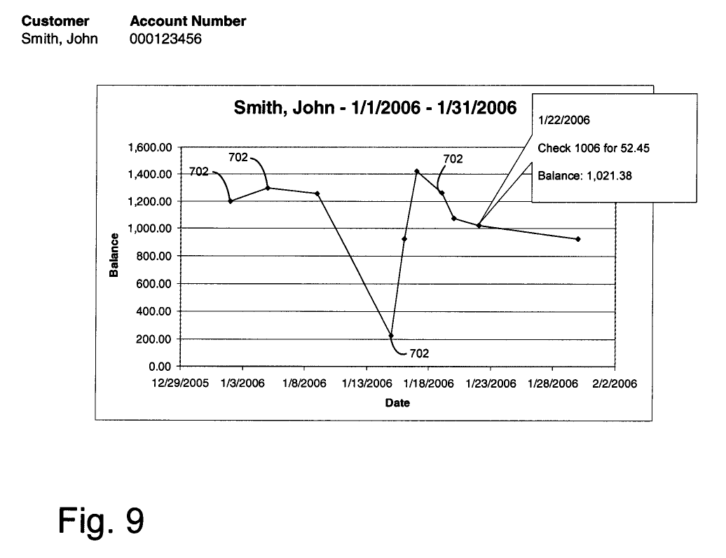

Turning now to FIG. 8, an exemplary embodiment of a statement display for a customer who may be in a picture-based behavioral group is shown. The graph depicted in FIG. 8 shows the deposits and withdraws of the customer during the reported month. The financial statement of FIG. 8 shows the same data as the statement of FIG. 7, but may be formatted in a way that a customer in a picture-based behavior group might more readily absorb. FIG. 7, on the other hand, may be formatted in a way that a customer in a text-based behavior group might more readily absorb. The display of FIG. 8 may include, for example, a plurality of data points 702 arranged on a graph. The data points 702 may be able to be chosen (i.e., by the click of a mouse, or by pressing them on a touch-sensitive display, for example), and may yield more specific information represented by the data point, as shown in FIG. 9.

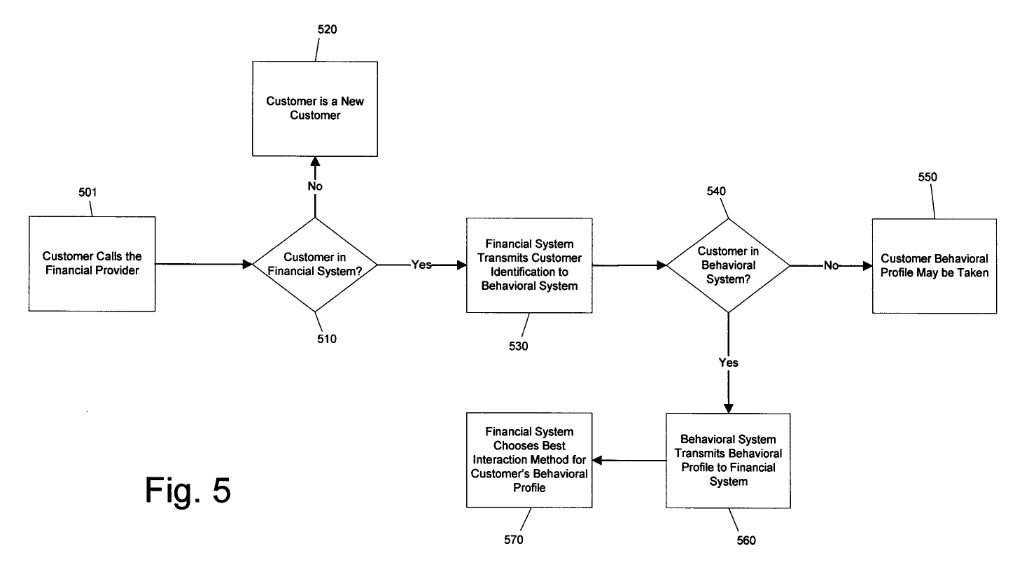

Turning now to FIG. 5, a customer may use the telephone or participate in a videoconference to interact with the financial institution. Or, the financial institution may contact the customer through the telephone or by a videoconference. The customer may be in a behavioral group that enjoys contact with a live customer service representative or may be driven to use the telephone or a videoconference, even though it would be outside of the normal method of contact for the customer's behavioral group. In the case of a customer initiating interaction with the financial institution, the customer may dial the number associated with the financial institution, shown in block 501. The financial system 120 may be in communication with the telephone network or other network so that it is associated with the number for the financial institution. The financial system 120 may recognize the customer's phone number as the number calling the financial institution, shown in block 510. The financial system 120 may not recognize the customer as having an account with the financial institution. If the customer does not exist in the financial system 120, the financial system 120 may recognize the customer as a new customer, shown in block 520. If the customer has an account in the financial system 120, the financial system 120 may transmit the customer's unique identifier to the behavioral system 130 via the financial system interface module 320, shown in block 530. The behavioral system 130 may query the customer database 230 with the unique identifier, shown in block 540. If the customer database 230 does not contain one or more behavioral profiles for the customer, the customer's behavioral profile may be taken, shown in block 550. If the customer database 230 contains one or more behavioral profiles associated with the customer's unique identifier, the behavioral system 130 may transmit the customer's one or more behavioral profiles to the financial system 120 via the behavioral system interface module 220, shown in block 560. The financial system 120 may then utilize the customer's one or more behavioral profiles to craft a suitable interaction with the customer, shown in block 570.

If the customer is in a transactional behavioral type, then the financial system 120 may utilize a system of menus and automated responses to the customer's query. For example, if the customer wishes to obtain the balance in his or her checking account with the financial institution, the financial system 120 may provide an automated menu system that reports the balance in a computer generated artificial voice. If the customer is a relationship-oriented behavioral type and wishes to obtain the balance in his or her checking account with the financial institution, then the financial system 120 may connect the customer to a live customer representative. The financial system 120 may display the customer's behavioral profile to the customer representative, so that the customer representative may assist the customer in performing the balance look-up in a style that matches the customer's behavioral profile. In an alternate embodiment, the financial system 120 may match a customer's one or more behavioral profiles with the behavioral profiles of the one or more customer representatives, so that the customer may be matched with a customer representative having the same or a similar behavioral profiles.

The customer may appear at the financial service store in order to meet with a customer representative in-person. This may occur even if the customer is not in a behavioral group which prefers in-person interaction because, for example, the service offered is not available for electronic enrollment, or the service is too complicated to explain on the computer or over the telephone. On the other hand, the customer may be in a behavioral group which enjoys the contact of an in-person interaction.

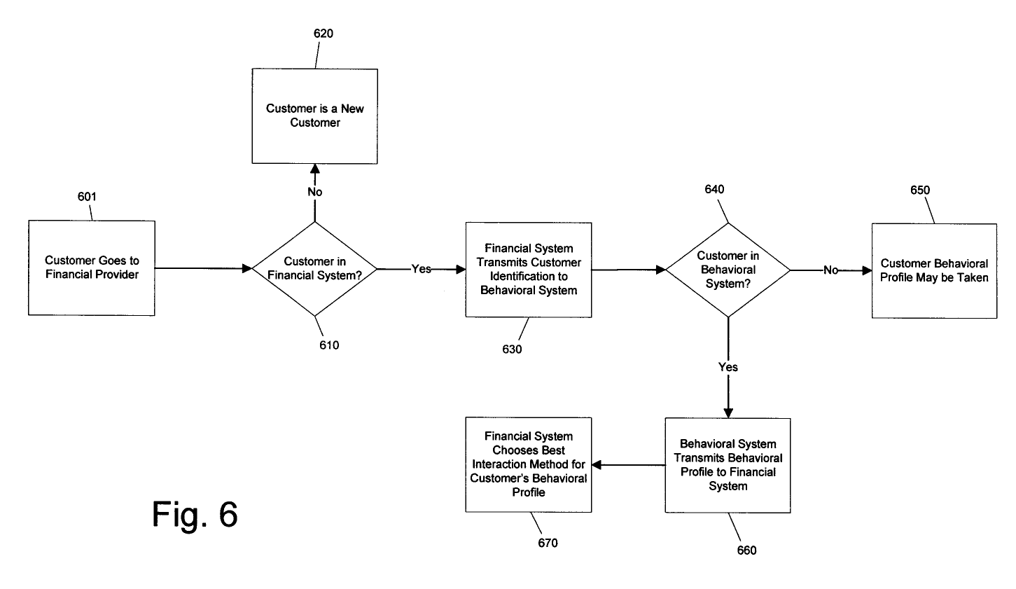

Turning now to FIG. 6, the customer may enter the financial service store, shown in block 601. In one embodiment, the customer may identify himself or herself to a customer representative. This may be accomplished by handing the customer representative a financial card, or by communicating the customer's name or other identifying information. The customer representative may enter the identification data into the financial system 120. The financial system 120 may use the identification data to find the customer's unique identification number. If the customer cannot be associated with a unique identification number, the financial system 120 may recognize the customer as a new customer, shown in block 620. If the customer is associated with a unique identification number, the financial system interface module 320 of the financial system 120 may transmit the unique identification number to the behavioral system interface module 220 of the behavioral system 130, shown in block 630. The behavioral system 130 may transmit the unique identification number to the customer database 230, where the customer database 230 may match the unique identification number to one or more behavioral profiles, shown in block 640. If the customer is not associated with one or more behavioral profiles, the customer's behavioral profile may be created, shown in block 650. The customer database 230 may transmit the one or more behavioral profiles to the behavioral system 130, which may then transmit the one or more behavioral profiles back to the financial system 120, shown in block 660. The one or more behavioral profiles associated with the customer's unique identification number may then be displayed or printed for the customer representative, shown in block 670. The customer representative may use this behavioral profile information in several different ways. For example, the customer representative may route the customer to a representative with a behavioral profile matching or matching as closely as possible the behavioral profile of the customer. Or, the customer representative may route the customer to a representative who is trained to interact with customers of the particular behavioral profile. It should be obvious to one of skill in the art that the customer representative may not need to make decisions regarding the customer; the financial system 120 may contain a list of the representatives working at the financial service store and their behavioral profiles or training histories, and may make routing decisions based on a match or association between the customer's behavioral profile and the customer representative's behavioral profile or training history without intervention.

In another embodiment of the present invention, the customer may be recognized by automated identification either before or after the customer enters the financial institution. For example, the customer may swipe a financial card containing a magnetic area or a barcode in a reader. The reader may be operable to read the magnetic area of the financial card or read the barcode of the financial card, and may transmit the information encoded in the magnetic area or barcode to the financial system 120. Additionally, the identification unit may operate with little or no interactivity. In some embodiments, the identification unit may not be visible to the customer. The identification unit may be a device to identify one or more customers based on observable biometric data, for example a customer's gait, head, face, retina, iris, voice, or any other observable characteristic so that the customer does not have to interact with the identification unit. Further, the financial card or associated device may have a global positioning system (“GPS”) transmitter, which could transmit GPS location information to the identification unit. The identification unit may also use GPS or other location-tracking techniques associated with a device associated with a customer to determine proximity (e.g., GPS on the customer's automobile, GPS and/or triangulation on a telecommunications device associated with the customer, etc.).

The financial institution may produce mailings to send to customers. For example, the financial institution may produce a monthly account statement for each customer, or may produce bills for services rendered or for fees incurred by the customer. The mailings may be created by an account representative of the financial institution, or may be automatically generated by the financial system 120. For each of the customers, the financial system 120 may transmit the customer's unique identification to the behavioral system 130 via the financial system interface module 320. The behavioral system 130 may transmit the unique identification to the customer database 230. If the customer database 230 has one or more behavioral profiles associated with the customer's unique identification, the customer database 230 may transmit the one or more behavioral profiles to the behavioral system 130. If no behavioral profiles exist, the customer database 230 may transmit an error message. The behavioral system 130 may transmit the one or more behavioral profiles or the error message to the financial system 120 via the behavioral system interface module 220.

The financial system 120 may utilize the one or more behavioral profiles received from the behavioral system 130 in generating the mailings. For example, if the customer is in a high-technology behavior type, the financial system 120 may send the mailing to the customer's associated e-mail account. Or, the financial system 120 may send a letter to the customer notifying the customer that the text of the mailing is also available over a network 110. On the other hand, if the customer is in a low-technology behavior type, then the financial system 120 might send a regular post office mailing to the customer, or may not mention in the mailing that the text of the mailing is available over a network 110. If the customer is in a picture oriented behavior type, the financial system 120 may generate bar graphs or a pie chart to conceptualize the data in the mailing. If the customer is in a text oriented behavior type, the financial system 120 may generate tables of numbers or text to conceptualize the data in the mailing. If the customer is in a heavy explanation behavior group, the mailing may include a large amount of information about the customer's account or may include a large amount of information about a new product or service. If the customer is in a light explanation group, the mailing may include a small amount of information about the customer's account or a simple overview of a new product or service. If the customer database 230 of the behavioral system 130 does not have one or more behavioral profiles associated with the customer's unique identification, the financial system 120 may also include a preliminary behavioral questionnaire with the customer's mailing, or may make a note in the customer's account information to obtain the behavioral information in the future.

The present invention encourages customer loyalty by crafting a customer experience which is synchronous with the customer's psychological and personality type. The present invention presents information to the customer in a way that the customer can most easily comprehend and use. The present invention may accomplish this by modulating the amount of information and the style of presentation of information into an amount and style that may enable the customer to more readily absorb it.

The embodiments of the present inventions are not to be limited in scope by the specific embodiments described herein. For example, the financial system 120 and the behavioral system 130 may be included as one system. Also, the present invention need not be used by a financial institution. It is within the scope of the invention that the invention be used wherever services may be provided to customers. Thus, such modifications are intended to fall within the scope of the following appended claims. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A method comprising:
collecting information about one or more users;
creating one or more behavioral profiles for the one or more users based on the information; and
adapting user interaction based on at least one of the one or more behavioral profiles for the one or more users.

2. The method of claim 1 wherein the information collected is selected from the group consisting of data from an on-line survey, data from on-line habits, data from a game, data from one or more card transactions, data from a telephone survey, data from a letter, and data from an in-person interview.

3. The method of claim 1 where the one or more behavioral profiles of the one or more users may be modified based on additional information collected after at least one of the one or more behavioral profiles is created.

4. The method of claim 1 where at least one of the one or more behavioral profiles is stored in a database.

5. The method of claim 1 where user interaction is selected from the group consisting of a web page, a computer image, a letter, a telephone call, an in-store interview, and an automated teller machine.

6. The method of claim 1 where the adaptation includes changing the amount of text presented to the one or more users based on at least one of the one or more behavioral profiles.

7. The method of claim 1 where the adaptation includes presenting predominantly figures or predominantly text to the one or more users based on at least one of the one or more behavioral profiles.

8. The method of claim 1 where the adaptation includes providing more interaction with a customer representative or less interaction with a customer representative to the one or more users based on at least one of the one or more behavioral profiles.

9. A method comprising:
collecting information about one or more users;
creating one or more behavioral profiles for the one or more users based on the information; and
transmitting at least one of the one or more behavioral profiles to a system for use in adapting user interaction based on at least one of the one or more behavioral profiles for the one or more users.

10. The method of claim 9 wherein the information collected is selected from the group consisting of data from an on-line survey, data from on-line habits, data from a game, data from one or more card transactions, data from a telephone survey, data from a letter, and data from an in-person interview.

11. The method of claim 9 where the one or more behavioral profiles of the one or more users may be modified based on additional information.

12. The method of claim 9 where at least one of the one or more behavioral profiles is stored in a database.

13. The method of claim 9 where user interaction is selected from the group consisting of a web page, a computer image, a letter, a telephone call, an in-store interview, and an automated teller machine.

14. The method of claim 9 where the adaptation includes changing the amount of text presented to the one or more users based on at least one of the one or more behavioral profiles.

15. The method of claim 9 where the adaptation includes presenting predominantly figures or predominantly text to the one or more users based on at least one of the one or more behavioral profiles.

16. The method of claim 9 where the adaptation includes providing more interaction with a customer representative or less interaction with a customer representative to the one or more users based on at least one of the one or more behavioral profiles.

17. A system comprising:
a collection unit to collect information about one or more users;
a behavioral unit for creating one or more behavioral profiles for the one or more users based on the information from the collection system; and
an interaction unit operable to adapt user interaction based on at least one of the one or more behavioral profiles for the one or more users.

18. The method of claim 17 wherein the information collected is selected from the group consisting of data from an on-line survey, data from on-line habits, data from a game, data from one or more card transactions, data from a telephone survey, data from a letter, and data from an in-person interview.

19. The method of claim 17 where the one or more behavioral profiles of the one or more users may be modified based on additional information.

20. The method of claim 17 where at least one of the one or more behavioral profiles is stored in a database.

21. The method of claim 17 where user interaction is selected from the group consisting of a web page, a computer image, a letter, a telephone call, an in-store interview, and an automated teller machine.
